(19) United States
(12) Patent Application Publication
(10) Pub. No.: US 2012/0320156 A1
(43) Pub. Date: Dec. 20, 2012

(54) Image recording apparatus

(76) Inventors: Chia Ching Chen, Hsinchu City (TW); Cheng Hao Chan, Hsinchu City (TW)

(21) Appl. No.: 13/134,802

(22) Filed: Jun. 17, 2011

(51) Int. Cl. H04N 13/02

(52) U.S. Cl. 348/46; 348/E13.074

(57) ABSTRACT

An image recording apparatus includes an image-sensing unit, a video-processing unit and a power module. The image-sensing unit further includes a frame, a first connector, and a first image-sensing module for capturing an image. The video-processing unit further includes a body, a second connector, a video-processing circuit, a video-output module, and a memory module. Through an electric engagement of the first connector and the second connector, image data captured by the first image-sensing module can be transmitted to the video-processing unit for being processed by the video-processing circuit into an electronic image file readable and storable to an ordinary computer apparatus. The electronic image file can be stored in the memory module. The video-processing module can also forward the electronic image file to a foreign video-displaying apparatus through the video-output module. The power module is to provide electricity to the image-sensing unit and the video-processing unit.

### BACKGROUND OF THE INVENTION

(1) Field of the Invention

The invention relates to an image recording apparatus, and more particularly to the image recording apparatus that can be used as a driving recorder mounted to a vehicle, an automobile or a motorcycle for example, or as a portable gear for recording surrounding 3D images. Specifically, the image recording apparatus of the present invention can provide a plurality of image-sensing devices to capture individual surrounding images at various viewing angles and depths for further compositing a 3D panorama image that can better rebuild a specific event.

(2) Description of the Prior Art

In a traffic accident or a specific event, confronting parties usually insist on words to their own rights. Judges or policemen can only mimic the accident or event from images provided by roadside monitors and the descriptions from both parties. Most of time, judgment from the foregoing clues is always unconvincing. Therefore, an accurate and complete image record of the accident is definitely required.

Currently, the driving recorder available in the marketplace is usually limited to have a single image sensor and a fixed focus radius. It happens to miss the number on the plate for having a too-wide viewing angle and to overlook the approaching vehicles for lateral sides for having a too-small viewing angle. Neither of above is tolerable. Further, the installation of the current driving recorder is usually interfered with the satellite navigation system originally existed in the limited space between the windshield and the driver. If the driver chooses to have both, it is inevitable to shrink and deflect the vision angle of the driver. Then, the possibility in driving accidents from the limited driving visibility is definitely irreducible.

Hence, an image recorder that can overcome the aforesaid shortcomings of the current products is definite to be highly welcome to the art.

### SUMMARY OF THE INVENTION

Accordingly, it is an object of the present invention to provide an image recording apparatus that has at least two image-sensing modules for capturing the exterior objects in a 3D imaging manner. By providing different viewing angles and depths to the image-sensing units, a 3D image surrounding the vehicle carrying the image recording apparatus can be composited to help reform a possible crime scene around the vehicle. Further, the image recording apparatus can also include an image-processing unit other than the image-sensing modules. The image-processing unit can be isolated away from the image-sensing modules that are located in the limited space between the windshield and the driver, to a proper location where forming an island to obstacle eyesight of the driver is no more a problem.

It is another object of the present invention to provide an image recording apparatus that includes at least two image-sensing modules for capturing exterior objects in a 3D imaging manner. These two image-sensing modules pivotally mounted at a frame can perform individually horizontal and pivotal image-capturing motions. Thereby, application flexibility in forming a 3D image, viewing at an enlarged viewing angle, or making possible in viewing simultaneously objects in the front and in the rear thereof can be obtained.

In the present invention, the image recording apparatus can include an image-sensing unit, a video-processing unit and a video-displaying unit.

The image-sensing unit can further include a frame, a first image-sensing module, a second image-sensing module and a first connector. The first image-sensing module and the second image-sensing module are mounted horizontally and separately by a predetermined spacing to opposing sides of the frame. Thereby, an exterior object can be captured at different viewing angles so as to form a 3D sense of the image. Specifically, the first image-sensing module and the second image-sensing module are pivotally mounted respectively to a first pivotal axis and a second pivotal axis perpendicular to the first pivotal axis. Respectively, the first image-sensing module and the second image-sensing module are pivotally rotated about the first pivotal axis and the second pivotal axis to change their own viewing angles.

The video-processing unit can further include a body isolated from the frame, a second connector, a third connector, a video-processing circuit, a video-output module, a memory module and a power module. Through an engagement of the first connector and the second connector, an electric connection between the video-processing unit and the image-sensing unit can be established in order to transmit image data captured by the first image-sensing module and the second image-sensing module to the video-processing module. The image data is further processed by the video-processing circuit into an electronic image file readable and storable to an ordinary computer apparatus. The electronic image file can be stored in the memory module. Further, the video-processing module can forward the electronic image file to a foreign video-displaying apparatus through the video-output module. The power module is to provide electricity to elements of the image recording apparatus.

The video-displaying unit can further include a display body and a fourth connector. The display body, isolated from the body of the video-processing unit, can be electrically connected with the video-processing unit through an engagement of the third connector and the fourth connector so as to transmit the electronic image file from the video-processing unit to the video-displaying unit for further displaying on a display screen of the display body.

In a preferable embodiment of the present invention, the video-output module can include at least one of the following two elements: an HDMI port and an AV OUT port. In addition, the memory module can have at least one of the following two elements: a slot for memory cards and a built-in flash memory. Furthermore, the video-processing unit can have at least a microphone for capturing the exterior sound, and can further include at least a speaker for audio broadcasting.

In one embodiment of the present invention, the connection between the first connector and the second connector can be one of the following two types: connection through an extension cable and connection through direct plug-in. Similarly, the connection between the third connector and the fourth connector can be also one of the following two types: connection through an extension cable and connection through direct plug-in.

All these objects are achieved by the image recording apparatus described below.

### BRIEF DESCRIPTION OF THE DRAWINGS

The present invention will now be specified with reference to its preferred embodiment illustrated in the drawings, in which:

FIG. 1 is a schematic block view of an image recording apparatus in accordance with the present invention;

FIG. 2A is a schematic front view of an embodiment of an image-sensing unit of an image recording apparatus in accordance with the present invention;

FIG. 2B is a schematic bottom view of FIG. 2A;

FIG. 2C is a schematic left-hand side view of FIG. 2A;

FIG. 3A is a schematic front view of an embodiment of an image-processing unit of an image recording apparatus in accordance with the present invention;

FIG. 3B is a schematic bottom view of FIG. 3A;

FIG. 3C is a schematic left-hand side view of FIG. 3A;

FIG. 4A is a schematic front view of an embodiment of an image-displaying unit of an image recording apparatus in accordance with the present invention;

FIG. 4B is a schematic bottom view of FIG. 4A;

FIG. 4C is a schematic left-hand side view of FIG. 4A;

FIG. 5A is a schematic front view of an embodiment of an image recording apparatus in accordance with the present invention, in an assembly state; and

FIG. 5B is a schematic rear view of FIG. 5A.

### DESCRIPTION OF THE PREFERRED EMBODIMENT

The invention disclosed herein is directed to an image recording apparatus. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In the present invention, the image recording apparatus can record the driving scene in a perspective form, i.e. in a 3D manner. Compared to the traditional driving recorder, the image recording apparatus of the present invention can better present the position relationship between vehicles. By providing more than two image recording apparatuses to a single vehicle, the viewing (panorama) angle can be even enlarged to 180 degrees. Namely, more information including panorama 3D images can be provided by the image recording apparatus to present the truth in a possible accident dispute. Further, for the image recording apparatus according to the present invention is provided in a three-isolated-element form, including the image-sensing unit, the image-recording unit and the video-displaying unit, a favor choice in consideration of the driver eyesight can be possible. Also, the record data of the apparatus can be wired to a foreign video integrating set in the same vehicle to better demonstrate the roadside scene during the riding.

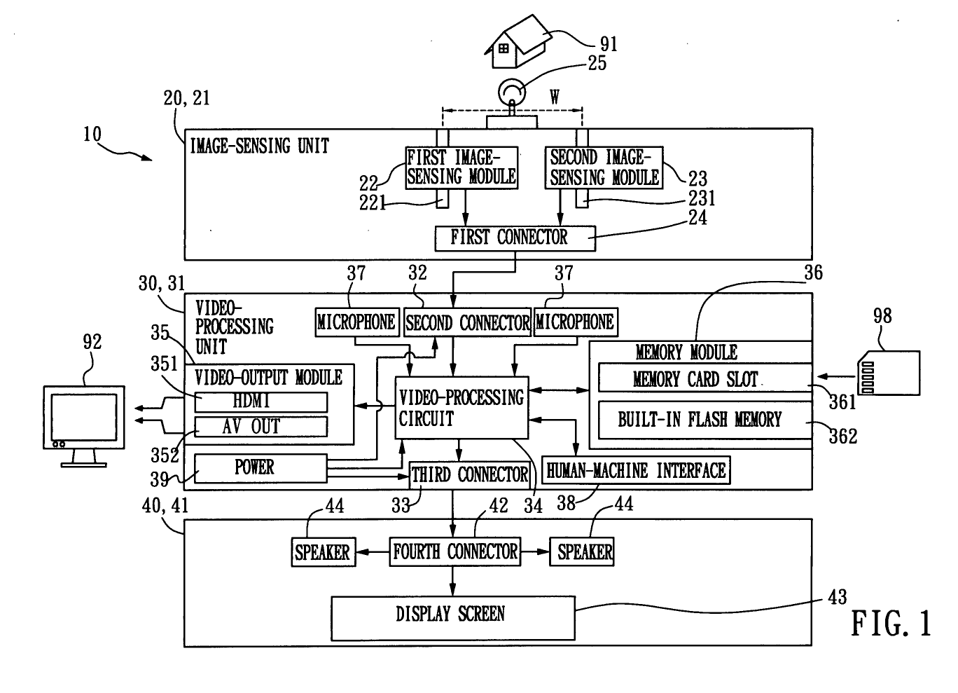

Referring now to FIG. 1, a schematic block view of a preferable image recording apparatus in accordance with the present invention is shown. The image recording apparatus 10 mainly includes an image-sensing unit 20, a video-processing unit 30 and a video-displaying unit 40. These three units 20, 30 and 40 are three discrete units that can be integrated electrically and functionally as a whole image recording apparatus by appropriate arrangements of connectors or by appropriate wiring in between to transmit electric signals.

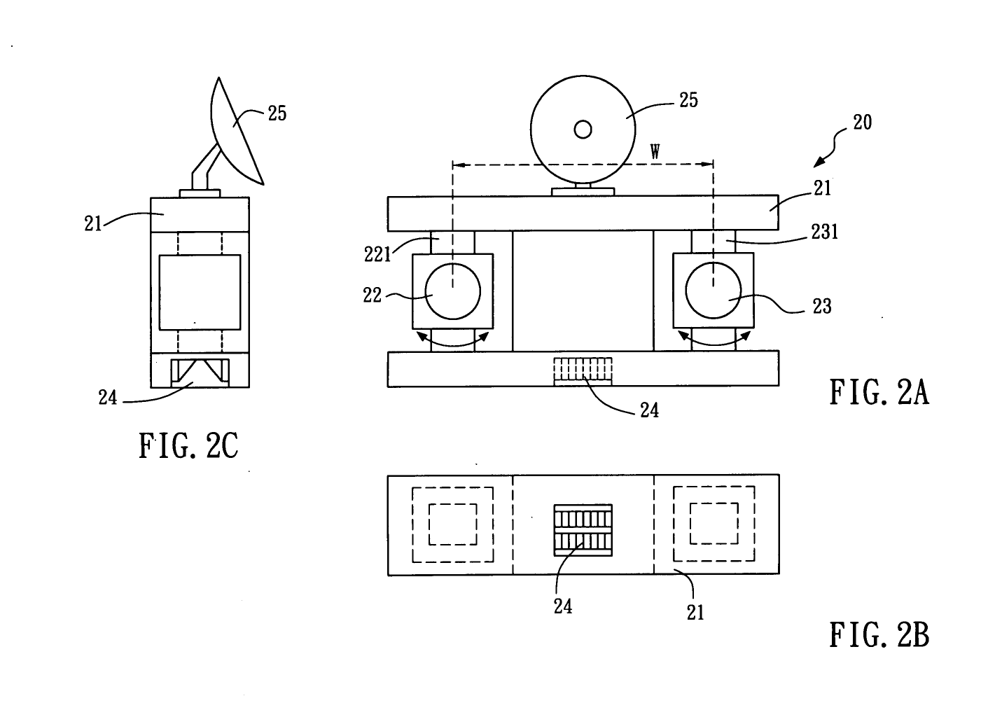

Refer now to FIG. 1 and further to FIGS. 2A, 2B and 2C, in which FIG. 2A, FIG. 2B and FIG. 2C are corresponding front, bottom and left-hand-side views of the image-sensing unit 20 of the apparatus 10. The image-sensing unit 20 for capturing images of foreign objects exterior to the apparatus 10 or the carrier vehicle can be directly mounted on the video-processing unit 30, or cabled at a predetermined distance to the video-processing unit 30. In the latter case, driver's view can be no longer interfered or partly blocked by the video-processing unit 30. The image-sensing unit 20 can be embodied to have a single sensing module or to have at least two sensing modules. While a single sensing module is applied to the image-sensing unit 20, the usage of the image recording apparatus is no more than that of a conventional driving recorder. While two image sensors or sensing modules are introduced, the image-sensing unit 20 of the present invention can then adjust focuses of lens sets to the same focus distance so as able to capture images of foreign objects in a 3D manner. Or, the two image-sensing modules can be adjusted to have different focus distances, one adjusted to have a panorama angle and the other one to be a telescope for recording the short-distanced number on the vehicle registration plate and watching the approaching vehicles, respectively. Furthermore, the two image-sensing modules can be angularly arranged to have one to record scene in the front of the vehicle and another to record objects in the rear or lateral side of the vehicle.

As shown, the image-sensing unit 20 of the preferable embodiment in accordance with the present invention can include a frame 21, a first image-sensing module 22, a second image-sensing module 23, a first connector 24 and a positioning mechanism 25. The first image-sensing module 22 and the second image-sensing module 23 are mounted horizontally and separately by a predetermined spacing W to opposing sides of the frame 21. In this embodiment, each of the image-sensing modules 22 and 23 can have its own lens set and image-sensing chip set (not shown in the figure). The lens set can be a prime lens set, an auto focus lens set or a zoom lens set to capture and form the image of a foreign object onto the image-sensing chip set. In the present invention, the image-sensing chip set can be a CCD image-sensing chip set or a CMOS image-sensing chip set for transforming the image data from the lens set into the corresponding electric signals.

In the present invention, the predetermined spacing W can be equal to the distance between two eyes, about 8 cm to 15 cm, such that a friendly 3D vision effect with appropriate depths of field, a quasi-human eyesight, can be generated by, for example, aiming the first image-sensing module 22 and the second image-sensing module 23 simultaneously at the foreign object 91. In the other application, the first image-sensing module 22 and the second image-sensing module 23 can be perpendicularly pivotally arranged to a first pivotal axis 221 and a second pivotal axis 231 at the frame 21. Upon such an arrangement, the first image-sensing module 22 and the second image-sensing module 23 can be pivotal about the first pivotal axis 221 and the second pivotal axis 231, respectively, to adjust the horizontal viewing angles of the first image-sensing module 22 and the second image-sensing module 23. Thereby, the two image-sensing modules 22 and 23 can be adjusted to aim at the same direction so as to form a 3D image, or to opposing directions at proper angling (say 10 to 45 degrees outwards, for example but not limited to) so as to generate a panorama effect (no more a 3D effect) up to 180 degrees. Also, it is also possible to have one of the two image-sensing modules 22 and 23 to watch the front of the vehicle and another to watch the rear of the vehicle. It is obvious that the angling combination of the image-sensing modules 22 and 23 is diverse and thus make the application of the image recording apparatus 10 of the present invention more flexible.

In this embodiment, the positioning mechanism 25 can be a removable mechanism fixed to the frame 21 for providing relevant means to fix the image-sensing unit 20 to a predetermined location or an object. These means include hanging, clamping, adhering and any the like. For example, in the case that the image recording apparatus 10 is used as a vehicle driving recorder, the positioning mechanism 25 can be a hook or a clip to fix the image recording apparatus 10 or the image-sensing unit 20 to the rear vision mirror. As shown in FIG. 2A, the positioning mechanism 25 is embodied as a suction cup adhered to the interior side of the windshield.

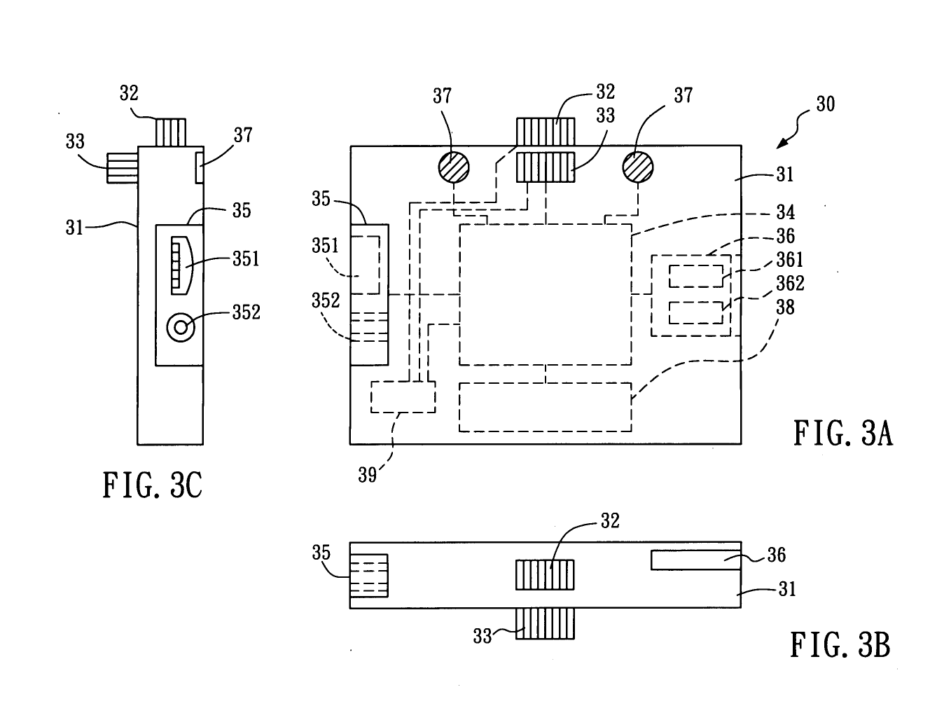

Referring now to FIG. 3A, FIG. 3B and FIG. 3C, the video-processing unit 30 of the image recording apparatus 10 in accordance with the present invention is schematically shown by a front view, a bottom view and a left-hand-side view, respectively.

The video-processing unit 30 is to receive image and audio signals, and further to transform these signals into digital data storable as a video file, which can be further output to the video-displaying unit 40. In the present invention, the video-processing unit 30 can prepare the display data according to the number of the image-sensing modules. For example, if there are two or more than two image-sensing modules, the video-processing unit 30 may present the display data (i.e. the rebuilt image data) on a display screen in a side-by-side manner. Also, the output signals from the video-processing unit 30 can be data for displaying ordinary plain images (for example, to display the images from the first image-sensing module 22), or data for displaying cross-over images from crossing the image data captured by different image-sensing modules so as to produce a 3D image at the video-displaying unit 40.

As shown, the video-processing unit 30 can further include a body 31, a second connector 32, a third connector 33, a video-processing circuit 34, a video-output module 35, a memory module 36, at least a microphone 37, a human-machine interface 38 and a power module 39. The body 31 and the frame 21 are independent and separated. Through an engagement of the first connector 24 and the second connector 32, an electric connection between the video-processing unit 30 and the image-sensing unit 20 can be established in order to transmit image data captured by the first image-sensing module 22 and the second image-sensing module 23 to the video-processing module 30. The image data is further processed by the video-processing circuit 34 into an electronic image file readable and storable to an ordinary computer apparatus. The electronic image file can be stored in the memory module 36. Further, the video-processing circuit 34 of the video-processing module 30 can forward the electronic image file to a foreign video-displaying apparatus 92 through the video-output module 35. The video-processing unit 30 of this embodiment can include two microphones 37 for capturing and recording the exterior sound in a stereo manner. The human-machine interface 38 is to provide the driver to operate and control the image recording apparatus 10, and can include one or more push buttons or rotational knobs.

In the present invention, the first connector 24 and the second connector 32 are particularly designed to be inter-pluggable structurally and electrically. In the art, following two connection techniques can be applied to the connection between the first connector 24 and the second connector 32: connection through an extension cable (not shown in the figure) and connection through direct plug-in. In the case that a connection cable is introduced to establish connection in between, the advantage of mounting the image-sensing unit 20 to a proper location in front of the driver and moving the video-processing unit 30 to a place away from the driver's eyesight can be obtained. For the image-sensing unit 20 of the present invention includes mainly the image-sensing modules 22 and 23 and the first connector 24, but excludes the image-processing circuit, card readers and video ports. Hence, the volume of the image-sensing unit 20 can made smaller to a degree that obstacle to the driver's eyesight is no more a problem to the inclusion of the image recording apparatus. Further, the drive safety can be substantially increased. On the other hand, in the case that the second connector 32 is directly engaged with the first connector 24, i.e. the video-processing unit 30 is integrated directly as a whole with the image-sensing unit 20, then a preferable portable combination for convenient image-capturing and processing can be formed. Or, through a proper positioning mechanism 25, such a combined set can be fixed to the vehicle as a conventional driving recorder.

In this embodiment, the video-output module 35 can include at least one of the following two elements: an HDMI port 351 and an AV OUT port 352. In addition, the memory module 36 can have at least one of the following two elements: a slot for memory cards 361 and a built-in flash memory 361. The slot 361 can be used to receive a foreign flash memory card 93 for storing the aforesaid electronic image file. In one application of the present invention, an addition extension cable can be introduced to connect the foreign video-displaying apparatus 92 to the HDMI port 351 or the AV OUT port 352 of the video-output module 35. Then, the video-processing unit 30 can be operated through the human-machine interface 38 to have the video-processing circuit 34 transmit the electronic image file, via the video-output module 35, to the foreign video-displaying apparatus 92 for displaying. In such an application, the foreign video-displaying apparatus 92 can be a conventional built-in vehicle multimedia integration apparatus (such as a DVD player). This built-in apparatus usually provides HDMI or/and AV IN video-input interfaces. With the built-in video-displaying apparatus 92 in the vehicle, the video-output module 35 of the present invention can directly output the image captured by the image-sensing unit 20 to the existing video-displaying apparatus 92 for further playing. Thus, the aforesaid video-displaying unit 40 of the present invention is no more needed. Definitely, cost and apparatus occupation can be further reduced. In other embodiment of the present invention, the foreign video-displaying apparatus 92 for playing the electronic image file stored or recorded by the image recording apparatus of the present invention can be a TV set, a computer monitor, a computer, or any displaying apparatus that can provide HDMI or AV IN video-input interface.

The power module 39 is to provide electricity to the image-sensing unit 20, the video-processing unit 30 and the video-displaying unit 40. The power module 39 can include a built-in rechargeable battery and a power plug (not shown in the figure) for receiving external electricity supply, say through a power cable. The external electricity supply can be a transformer, a power from other apparatus, the power from the auto cigarette plug, or any the like. The external electricity supply can be also used to charge the rechargeable battery. In this embodiment, the power module 39 can be electrically connected to the video-processing circuit 34, the second connector 32 and the third connector 33. The power from the power module 39 can be further provided to the add-on first connector 24 of the image-sensing unit 20 and the fourth connector 42 of the video-displaying unit 40 which are engaged with the video-processing unit 30 by direct plugging or cabling. Upon such an arrangement, the image-sensing unit 20 does not need any built-in power supply and thus can be further reduced in sizing and weighting. In another embodiment of the present invention not shown herein, the video-displaying unit 40 can have its own built-in rechargeable battery and external power plug, and thereby can achieve an additional function in independent image-displaying.

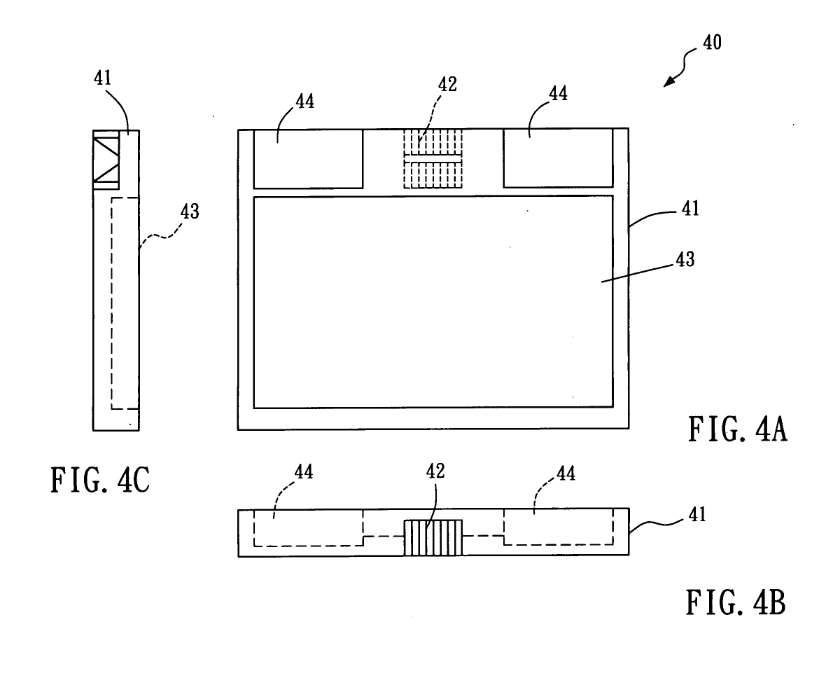

Refer now again to FIG. 1 and also to FIGS. 4A, 4B and 4C, in which FIG. 4A, FIG. 4B and FIG. 4C are schematically a front view, a bottom view and a left-hand-side view of a preferable embodiment of the video-displaying unit 40 of the image recording apparatus 10 in accordance with the present invention. The video-displaying unit 40 is mainly to display the image and sound processed by the video-processing unit 30, and is preferably a displayer that can play both the ordinary image files and the perspective 3D image files. The video-displaying unit 40 can have two speakers. As shown, the preferable video-displaying unit 40 of the present invention includes a displayer body 41, a fourth connector 42 and at least a speaker 44 (two shown in this embodiment). The displayer body 41 can further include a display screen 43, for example (but not limited to) an LCD screen. Though the displayer body 41 and the body 31 of the video-processing unit 30 are discrete structures, yet the video-displaying unit 40 and the video-processing unit 30 can be electrically connected through the engagement of the fourth connector 42 and the third connector 33. Upon such an arrangement, the video-processing circuit 34 can transmit the electronic image file, including both the electronic image file captured by the image-sensing unit 20 and the electronic image file stored in the memory module 36, to the displayer body 41 for further displaying on the displayer screen 43.

In the present invention, the fourth connector 42 and the third connector 33 are particularly designed to be inter-pluggable structurally and electrically. In the art, following two connection techniques can be applied to the connection between the fourth connector 42 and the third connector 33: connection through an extension cable (not shown in the figure) and connection through direct plug-in. In the case that a connection or extension cable is introduced to establish connection in between, the advantage of mounting the video-displaying unit 40 to a proper location in front of the driver but not blocking the driver's eye vision, for example the audio set or the conditioner control panel of the vehicle, and moving the video-processing unit 30 to a place away from the driver's eyesight can be obtained. On the other hand, in the case that the fourth connector 42 is directly engaged with the third connector 33, i.e. the video-processing unit 30 is integrated directly as a whole with the video-displaying unit 40.

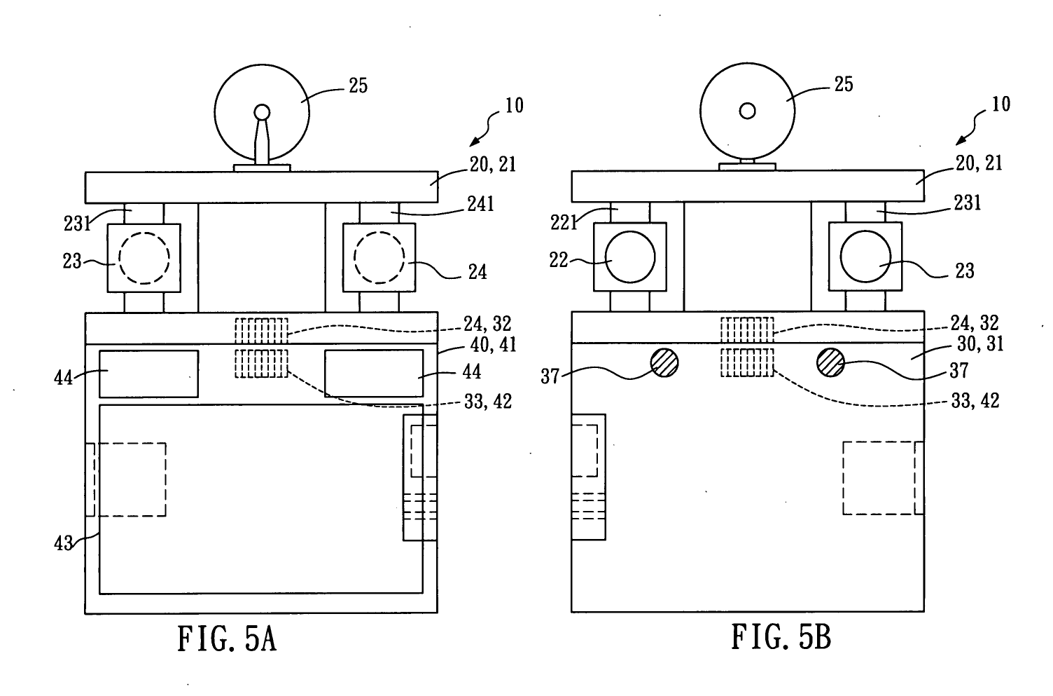

Refer now to FIG. 5A and FIG. 5B and also to FIG. 1, in which FIG. 5A and FIG. 5B are schematically a front view and a rear view of the preferable embodiment of the image recording apparatus 10 in an assembly state in accordance with the present invention. In this embodiment, the first connector 24 is mounted to a bottom surface of the frame 21 and is formed as a shallow socket. The second connector 32 is mounted to a top surface of the body 31 and is formed as a protrusion plug. Upon such an arrangement, the second connector 32 can directly mate the first connector 24 to position the video-processing unit 30 bottom to the image-sensing unit 20 with the top surface of the video-processing unit 30 flush with the bottom surface of the image-sensing unit 20, so that a pretty as-a-whole appearance can be present.

In addition, the third connector 33 as a protrusion plug is located to the rear surface of the body 31 at a position close to the top surface thereof. On the other hand, the fourth connector 42 as a corresponding shallow socket is located to the rear surface of the displayer body 41 at a position close to the top surface thereof. Upon such an arrangement, the fourth connector 42 can directly mate the third connector 33 to position the rear surface of the video-displaying unit 40 to contact evenly with the rear surface of the video-processing unit 30 so as to present a compact, unique and beautiful appearance.

While the present invention has been particularly shown and described with reference to a preferred embodiment, it will be understood by those skilled in the art that various changes in form and detail may be without departing from the spirit and scope of the present invention.

I claim:

1. An image recording apparatus, comprising:
an image-sensing unit, further including a frame, a first image-sensing module and a first connector; the first image-sensing module being to capture an image of a foreign object;
a video-processing unit, further including a body, a second connector, a video-processing circuit, a video-output module, and a memory module; the body being isolated from the frame but able to electrically connect with the image-sensing unit through an engagement of the first connector and the second connector, such that image data captured by the first image-sensing module is able to be transmitted to the video-processing unit and be further processed by the video-processing circuit into an electronic image file readable and storable to an ordinary computer apparatus; the electronic image file being stored in the memory module; the video-processing module being able to forward the electronic image file to a foreign video-displaying apparatus through the video-output module; and
a power module for providing electricity to the image-sensing unit and the video-processing unit.

2. The image recording apparatus according to claim 1, wherein said image-sensing unit further includes a second image-sensing module, said first image-sensing module and the second image-sensing module being mounted horizontally and separately by a predetermined spacing to opposing sides of said frame, such that an exterior object can be captured in a form of a 3D perspective sense.

3. The image recording apparatus according to claim 2, wherein said first image-sensing module and said second image-sensing module are pivotally mounted respectively to a first pivotal axis and a second pivotal axis perpendicular to the first pivotal axis, said first image-sensing module and said second image-sensing module being pivotally rotated respectively about the first pivotal axis and the second pivotal axis so as to change viewing angles of said first image-sensing module and said second image-sensing module.

4. The image recording apparatus according to claim 1, wherein said engagement of said first connector and said second connector is one of two following types: connection through an extension cable and connection through direct plug-in.

5. The image recording apparatus according to claim 1, wherein said video-output module includes at least one of an HDMI port and an AV OUT port, and said memory module includes at least one of a slot for memory cards and a built-in flash memory.

6. The image recording apparatus according to claim 1, wherein said video-processing unit further includes a third connector, and said image recording apparatus further includes a video-displaying unit, the video-displaying unit further including a display body and a fourth connector, the display body having a display screen and being isolated from said body but able to electrically connect with said video-processing unit through another engagement of said third connector and the fourth connector so as to allow said video-processing circuit to transmit said electronic image file from said video-processing unit to the video-displaying unit for further displaying on the display screen.

7. The image recording apparatus according to claim 6, wherein said another engagement of said third connector and said fourth connector is one of two following types: connection through an extension cable and connection through direct plug-in.

8. The image recording apparatus according to claim 6, wherein said video-processing unit further has at least a microphone for capturing exterior sounds, and said video-displaying unit further has at least a speaker for audio broadcasting.

9. An image recording apparatus, comprising:
an image-sensing unit, further including a frame, a first image-sensing module, a second image-sensing module, and a first connector, the first image-sensing module and the second image-sensing module being mounted horizontally and separately by a predetermined spacing to opposing sides of the frame, such that an exterior object can be captured in a form of a 3D perspective sense, the first image-sensing module and the second image-sensing module being pivotally mounted respectively to a first pivotal axis and a second pivotal axis perpendicular to the first pivotal axis, the first image-sensing module and the second image-sensing module being pivotally rotated respectively about the first pivotal axis and the second pivotal axis so as to change viewing angles of the first image-sensing module and the second image-sensing;
a video-processing unit, further including a body, a second connector, a third connector, a video-processing circuit, a video-output module, and a memory module, the body being isolated from the frame but able to electrically connect with the image-sensing unit through an engagement of the first connector and the second connector, such that image data captured by the first image-sensing module is able to be transmitted to the video-processing unit and be further processed by the video-processing circuit into an electronic image file readable and storable to an ordinary computer apparatus, the electronic image file being stored in the memory module, the video-processing module able to forward the electronic image file to a foreign video-displaying apparatus through the video-output module;
a video-displaying unit, further including a display body and a fourth connector, the display body having a display screen and being isolated from the body but able to electrically connect with the video-processing unit through another engagement of the third connector and the fourth connector so as to allow the video-processing circuit to transmit the electronic image file from the video-processing unit to the video-displaying unit for further displaying on the display screen; and
a power module for providing electricity to the image-sensing unit the video-processing unit and the video-displaying unit.

10. The image recording apparatus according to claim 9, wherein said video-output module includes at least one of an HDMI port and an AV OUT port, said memory module includes at least one of a slot for memory cards and a built-in flash memory, said video-processing unit further includes at least a microphone for capturing exterior sounds, and said video-displaying unit further includes at least a speaker for audio broadcasting.
